(19) United States
(12) Patent Application Publication
(10) Pub. No.: US 2007/0190208 A1
(43) Pub. Date: Aug. 16, 2007

(54) Novel food production process

(75) Inventors: Hugo Streekstra, Amsterdam (NL); Luppo Edens, Rotterdam (NL)

Correspondence Address: NIXON & VANDERHYE, PC, 901 NORTH GLEBE ROAD, 11TH FLOOR, ARLINGTON, VA, 22203, US

(73) Assignee: DSM IP ASSETS B.V., TE Heerlen (NL)

(21) Appl. No.: 10/588,906

(22) PCT Filed: Feb. 28, 2005
(86) PCT No.: PCT/EP05/02159

§ 371 Date: Aug. 9, 2006

(30) Foreign Application Priority Data
Feb. 26, 2004 (EP) 04075628.0

(51) Int. Cl. A23L 3/3463

(52) U.S. Cl. 426/63; 426/615; 426/618; 426/656

(57) ABSTRACT

Process for the production of a food or feed product, comprising adding an enzyme to the surface of an intermediate form of the food or feed product, and subsequently applying at least one heating step, whereby the enzyme is capable of modifying amino acids present in the intermediate form of the food or feed product. The invention also relates to food or feed products obtained by the process of the invention.

The present invention relates to a process for the production of a food or feed product involving at least one heating step, and to food or feed products obtained by such a process. Furthermore, the present invention relates to a novel method to apply an enzyme suitable for the process according to the invention.

Acrylamide has been produced commercially for a number of years. Hence, its toxicological status is well evaluated. Acrylamide is mainly used for the production of polyacrylamide, and the latter compound is used for various applications, such as the production of drinking water, soil stabilization, industrial wastewater treatment, the winning of oil, and laboratory applications.

Acrylamide is considered as probably carcinogenic for animals and humans. In 1991, the Scientific Committee on Food investigated monomeric acrylamide in contact food materials, and it concluded that acrylamide is a genotoxic carcinogen. Bergmark et aL (Chem. Res. Toxicol., 10, 78-84 (1997)) demonstrated that acrylamide is a component in tobacco smoke. This was the first link between the formation of acrylamide and the heating of biological material. Recently, the occurrence of acrylamide in a number of fried and oven-prepared foods was published (Tareke et al., Chem. Res. Toxicol. 13, 517-522. (2000)), causing world-wide concern. Further research revealed that considerable amounts of acrylamide are detectable in a variety of baked, fried and oven-prepared common foods, and it was demonstrated that the occurrence of acrylamide in food was a result of the heating process.

The official limit for acrylamide contamination in food products in the UK has been set at 10 ppb (10 micrograms per kilogram). The values reported in the literature exceed this value in many products, for instance cereals, bread products, coffee, potato chips (French fries), and potato crisps.

A relation between the administered dose of acrylamide and tumor incidence was found in tests in which rats—whose fate was followed for two years—were fed acrylamide via drinking water (Friedman, H.L. et. al., Fundam. Appl. Pharmacol. 85:154-168 (1986); Johnson et. al., Toxicol. Appl. Pharmacol. 85:154-168 (1986)). Tareke etal. investigated hemoglobin-bound acrylamide in rats—as N-(2-carbamoylethyl)-valine—in relation to an acrylamide-containing diet. Combining these data, it was calculated that a daily uptake of acrylamide of 1.6 μg/kg corresponds to a cancer risk of 7*10⁻³ for humans from life-long exposure.

A pathway for the formation of acrylamide from amino acids and reducing sugars has been proposed (Mottram et al. Nature 419:448. (2002)). According to this hypothesis, acrylamide is formed during the Maillard reaction. During baking, frying and roasting, Maillard reactions contribute strongly to the color, smell and taste of the product. Associated with the Maillard reactions is the Strecker degradation of amino acids, and a pathway towards acrylamide was proposed. The formation of acrylamide became detectable when the temperature exceeded 120° C., and the highest formation rate was observed at around 170° C. When both asparagine and glucose were present, the highest levels of acrylamide were observed, while glutamine and aspartic acid only gave rise to trace quantities.

The fact that acrylamide is formed mainly from asparagine and glucose may explain the high levels acrylamide in oven-cooked, fried or roasted plant based products such as bread, roast potatoes, French fries, coffee, or potato crisps. Several plant raw materials are known to contain substantial levels of asparagine. Asparagine is the dominant free amino acid in potatoes (940 mg/kg, corresponding to 40% of the total amino-acid coritent). In wheat flour, asparagine is present at a level of circa 167 mg/kg, corresponding to 14% of the total free amino acid content (Belitz and Grosch, in: Food Chemistry, Springer, New York, 1999).

Therefore, in the interest of public health, there is an urgent need for food products that have substantially lower levels of acrylamide or, preferably, are devoid of it. In first instance, research activities have been initiated in order to unravel the mechanism of acrylamide formation in food products. So far, the results have not yet led to a satisfactory solution of the problem. Currently, food companies are investigating the possibilities to avoid the formation of acrylamide by lowering the temperature of the oven cooking and roasting processes. However, such adaptations will inherently result in food products with altered taste properties (less Maillard products), or with an altered composition (higher fat content).

Co-pending patent application WO04/030468 provides a method to prevent acrylamide formation by treatment of an intermediate form of a food product with an enzyme that breaks down amino acids involved in the formation of acrylamide. However, in particular cases this method may be difficult to apply. For instance, the intermediate form may contain a high level of such amino acids, as is the case for the asparagine content of potato-derived products. Such high levels may require processing times that are too long, and the product quality may be compromised by extensive modification of major components. Also, if the intermediate form is a macroscopic fraction or cut of a solid or semi-solid food, it may be impossible to expose the whole supply of the relevant amino acid(s) to the enzyme.

Surprisingly, we have found that it is not necessary to remove or convert all of the relevant amino acid(s), but that it is sufficient to do so in a thin layer at the surface of the product. The removal or conversion of these amino acids is preferably obtained by the addition of a suitable enzyme.

Therefore the present invention provides a process for the production of a food or feed product comprising:
adding an enzyme to the surface of an intermediate form of the food or feed product,
and heating at least a part of the intermediate food or feed product to a temperature of 100° C. or higher, whereby the enzyme is capable to modify an amino acid present in the intermediate form of the food product and which amino acid is involved in the formation of acrylamide in absence of the enzyme during the heating of the intermediate food product.

In general, the heating of the at least part of intermediate food or feed product takes place after the adding of the enzyme.

Preferably, an enzyme is used which is capable of modifying a side chain of the amino acid, more preferably of the amino acid asparagine or glutamine.

Advantageously the enzyme is added in an amount sufficient to modify an amino acid to such an extent, that 50% less, preferably 70% less, or more preferably 90% less acrylamide is formed during the subsequent heating step, compared with a food or feed product where no enzyme has been added to the intermediate form.

According to the invention, a suitable enzyme is applied to the outside of the food product intermediate. Preferably, the outside of the food product intermediate represents the surface to which the heat of the heating step is applied. We have also found that the diffusion of the suitable enzyme from the outside of the food product intermediate into the interior is sufficient to reduce the levels of the relevant amino acid(s) in the outer layer, hereby effectively reducing the amount of acrylamide formed upon heating.

The term “food” is defined to include both food stuffs for human consumption and food stuffs for animal consumption. Hence the term “food” should be taken to mean “food, pet food or feed” throughout this document.

The thickness of the outer layer of a food product depends on the food product, its preparation and its application. Generally, the outer layer is 3 mm thick, preferably at most 2 mm and most preferably at most 1 mm thick.

Applying a suitable enzyme to the outside of a food product intermediate, has a number of advantages over the existing art. Processing times are shorter, because the enzyme has to diffuse through a thin layer only, and not through the whole product. Less enzyme is needed, because a lower amount of amino acids has to be removed, which results in a cost advantage. Product quality is higher, because the amino acids in the interior are not affected. Finally, the present invention can be used in solid and semi-solid foods.

The present invention provides a process for the production of a food product involving at least one heating step, comprising adding a suitable enzyme to an intermediate form of said food product prior to said heating step, where said enzyme effectively reduces the level of amino acids involved in the formation of acrylamide during said heating step, and where said enzyme is introduced at the surface of said intermediate form, and/or said heating step is applied to the surface to which said enzyme has been applied.

An intermediate form of the food product is defined herein as any form that occurs during the production process that preferably already has the shape and size of the food product that is subjected to the heating step(s). In another sense, it is characteristic of the intermediate form of the food product is that its surface areas are substantially the same as the surface areas of the form of the food product that is subjected to the heating step(s), although it is admissible that additional surface areas are formed after introduction of the enzyme, for instance by cutting, as long as the new surface area constitutes a relatively minor fraction of the total surface are, preferably less than 20% of the total area, more preferably less than 15% of the total area and most preferably less than 10% of the total area.

The intermediate form does not necessarily comprise all the individual raw materials and/or additives and/or processing aids. For example, for the food product French fries, the intermediate forms comprise the raw cut potato slices, the cooked potato slices, and the potato slices after a first industrial frying step (but before subsequent frying steps). Whether, when, or where other components, such as seasonings, flavorings, or other additives, are added, is not relevant with respect to the present invention.

The intermediate form to which the enzyme is applied does not have to be subjected to the heating step directly—additional processing steps may take place between the addition of the enzyme and the heating step.

The food product may be made from at least one raw material that is of plant origin, for example tubers such as potato, sweet potato, or cassava; legumes, such as peas or soy beans; aromatic plants, such as tobacco, coffee or cocoa; nuts; or cereals, such as wheat, rye, corn, maize, barley, groats, buckwheat, rice, or oats. Also food products made from more than one raw material are included in the scope of this invention, for example food products comprising both corn and potato.

Examples of food products in which the process according the invention can be suitable, are products comprising a powdered ingredient. Generally, powder-based products have a dough as secondary stage. A dough is defined here as any mixture comprising a powder obtained from an edible substance and a consumable liquid, with a consistency suitable to be shaped into a definite shape. The shape that is subjected to the heating step—later in the production process—constitutes the intermediate form as defined for the present invention.

The powder may be a cereal flour—and the final product may be a baked product, such as bread, pastry, cake, pretzels, bagels, Dutch honey cake, cookies, gingerbread, gingercake, or crispbread; the final product from a cereal flour may also be a fried product, such as corn chips, tortilla chips, or taco shells. The powder may also be made from other plants, such as potatoes or other tubers, asparagus or other stem vegetables, bananas or other fruits, or legumes.

The powder may also be derived from animals, for instance in the case of fishmeal or shrimps.

The powder may be derived from a raw edible material, or from cooked material. An example of a powder made from cooked material is instant mashed potato powder, which may be used to make a dough with a consistency suitable to be shaped into potato croquettes.

Powders of various origins can be easily combined, and a dough may be prepared from such composite powders as well. The dough may be given its definite shape by hand, or it can be processed mechanically to obtain its definite shape, for instance by an extrusion process.

Another class of food products in which the process according the invention can be suitable, is formed by products comprising intact edible parts of plants, animals or fungi, or cuts or slices thereof. Examples of this class are fried products made from plant tubers, such as French fries (pommes frites, potato chips) or potato crisps, made from fruits, such as banana or apple chips, or made from stem vegetables, such as asparagus chips. Other examples of foods comprising intact edible materials are meat, fish or mushrooms.

Another class of food products in which the process according the invention can be suitable is formed by semi-solid products. Examples of this class are tofu or tempeh, made from soy beans, or cheese. The semi-solid food intermediate may be subjected to a subsequent heating step, such as when pieces of tofu are fried. The semi-solid food intermediate can also be used as a topping of another food before the heating step, such as cheese topping of pizza or potato gratin.

Raw materials as cited above are known to contain substantial amounts of amino acids that are involved in the formation of acrylamide during the heating step of the production process. Alternatively, these amino acids may originate from other sources than the raw materials, e.g. from protein hydrolysates, such as yeast extracts, meat extracts, soy hydrolysate, casein hydrolysate and the like, or coatings or toppings, such as cheese, semi-solid soy products, or bread crumbs, which may be used as an additive in the food production process.

A preferred production process is the baking of a shaped dough comprising cereal flour and/or flours obtained from other plants. Another preferred production process is the deep-frying of a dough-based intermediate product. Another preferred production process is the baking of a composite food, such as the baking of pizza or potato gratin. Another preferred production process is the deep-frying of cuts or slices of edible parts from a plant, for instance of thin potato slices to make potato crisps, or of coarse potato cuts to make French fries. Another preferred production process is the deep-frying of a semi-solid food, such as tofu.

Preferred heating steps are those at which a part of the intermediate food product, in particular the surface of the food product, is exposed to temperatures at which the formation of acrylamide is promoted, for example 100° C. or higher, preferably 105° C. or higher, more perferably 120° C. or higher, or temperatures up to 250° C. The heating step in the process according to the invention may be carried out in ovens, for instance at a temperature between 150-250° C., such as for the baking of bread and other baked products, or in oil such as the frying of French fries, potato crisps, or tofu, for example at 150-200° C.

The enzyme used in the process of the invention preferably is an enzyme capable of modifying the side chains of amino acids that are involved in the formation of acrylamide during the heating step of the production process, in such a way that less acrylamide is formed during this heating step than without treatment with this enzyme. By “enzyme” is meant “one enzyme” as well as “a combination of more than one enzyme”. Preferably, the enzyme is capable of modifying the side chain of at least one of the amino acids asparagine or glutamine. More preferably, the enzyme is capable of modifying the amino acid asparagine, when the asparagine is present as the free amino acid, or when it is bound to other molecules, such as in peptides, proteins, lipoproteins, or glycoproteins.

In another preferred embodiment, the enzyme used in the process of the invention belongs to enzyme category EC 3.5.1 (Enzymes acting on Carbon-Nitrogen bonds, other than peptide bonds). Particularly preferred enzyme categories are asparaginase (EC 3.5.1.1), glutaminase (EC 3.5.1.2), glutamin-(asparagin-)ase (EC 3.5.1.38), peptidyl glutaminase (EC 3.5.1.43), or protein-glutamine glutaminase (EC 3.5.1.44).

Preferably, the enzyme preparation used in the process of the invention is derived from a microorganism and obtained by fermentation processes known in the art. The microorganism may be a bacterium, a fungus or a yeast.

Asparaginase can be obtained from various sources, for example from plants, from animals, or from microorganisms, such as Escherichia, Erwinia, Streptomyces, Pseudomonas, Aspergillus and Bacillus species. An example of a suitable Escherichia strain is Escherichia coli. An example of a suitable Erwinia strain is Erwinia chrysanthemi. Examples of suitable Streptomyces strains are Streptomyces lividans or Streptomyces murinus. Examples of suitable Aspergillus strains are Aspergillus oryzae, Aspergillus nidulans, or Aspergillus niger. Examples of suitable Bacillus strains are Bacillus alkalophilus, Bacillus amyloliquefaciens, Bacillus brevis, Bacillus circulans, Bacillus coagulans, Bacillus lautus, Bacillus lentus, Bacillus licheniformis, Bacillus megaterium, Bacillus stearothermophilus, or Bacillus subtilis. An example of suitable methods to obtain asparaginase from Bacillus, Streptomyces, Escherichia or Pseudomonas strains is described in WO03/083043. WO03/083043 does not, however, disclose the use of asparaginase to decrease the amount of acrylamide in food as described in the present invention. Glutaminase enzymes are commercially available from the companies Daiwa Kasei KK and Amano.

Preferably, the enzyme is obtained from food-grade organisms, for example Aspergillus niger or Bacillus subtilis.

Preferably the enzyme is provided in a liquid form, to allow easy dispersion on the surface of the product, but dry powdered forms are also possible. Irrespective of the formulation of the enzyme, any additives and stabilizers known to be useful in the art to improve and/or maintain the enzyme's activity can be applied. When the enzyme is contained in a liquid form, it may be applied to the product by any conceivable method, for instance by soaking or spraying.

Following application of the enzyme to the product, a certain processing time is required to allow the enzyme to act before the food is heated, because a substantial reduction of the amino acids capable of generating acrylamide must be obtained, and because the heating step will generally inactivate the enzyme. Generally the processing time will take at most 2 hours, preferably at most 1.5 hour and most preferably at most 1 hour. In general processing times of at least 5 minutes can be reached. Preferably, the processing time is between 10 minutes and 2 hours, more preferably between 15 minutes and 1.5 hours, and most preferably between 20 minutes and 1 hour. It is to be understood that the more enzyme is added a shorter processing time can suffice for the enzyme to reach the desired effect and vice versa.

In another aspect of the invention, the invention relates to a food or feed product obtainable by the process according to the invention.

The food or feed product differs from the food or feed obtained by the process according to WO04/030468 in the following aspect: the food or feed product obtained in the process according to the invention comprises a low amount of acrylamide, but also a high amount of asparagine or glutamine. In contrast, the food or feed obtained according to the process disclosed in the prior art also contains a significantly decreased amount of asparagine or glutamine. This is not desirable from a nutritional view. In the process according to the invention at least 50% of the amount of asparagine or glutamine is retained in the food product obtainable by the process. Preferably even 60% of the original amount of asparagine or glutamine is present, even more preferably more than 70% and most preferably more than 80%.

### MATERIALS & MOTHODS

### Acrylamide Measurement

Sample Pretreatment

600 mg dried and homogenized sample was extracted using 5 ml of milliQ water. 1 μg of internal standard ¹³C₃ acrylamide in solution (CIL) was added to the extract. After 10 minutes of centrifugation (6000 rpm), 3 ml of the upper layer was brought on an Extreluut-3BT column (Merck). Using 15 ml of ethylacetate, acrylamide was eluted from the column. Ethylacetate was evaporated under a gentle stream of nitrogen, to bring the volume down to approximately 0.5 ml.

Chromatographic Conditions

The ethylacetate solution was analyzed using gas chromatography. Separation was obtained using a CP-Wax 57 (Varian) column (length 25 m, internal diameter 0.32 mm, film 1.2 μm) and helium as the carrier gas with a constant flow of 5.4 ml/min. Splitless injection of 3 μl was performed. Oven temperature was kept at 50° C. for 1 minute, after which the temperature was increased with 30° C./min to 220° C. After 12 minutes of constant temperature of 220° C. the oven was cooled down and stabilized before the next injection.

Detection was performed using on-line chemical ionization mass spectrometry in positive ion mode, with methane as ionization gas. The characteristic ions m/z 72 (acrylamide) and m/z 75 (¹³C₃ acrylamide) were monitored for quantification.

Used Equipment

| | |
|---|---|
| GC: | HP6890 (Hewlet Packard) |
| MSD (mass selective detector): | HP5973 (Hewlet Packard) |

### Measurement of Asparaginase Activity

Asparaginase activity was measured according to Shirfrin et al. (Shirfrin, S, Parrott, C. L., and Luborsky, S. W. (1974), Journal of Biological Chemistry 249, 1445 -1340). The principle of this enzyme assay is the determination of the released NH₃ as a result of asparaginase activity.

In order to measure released NH₃, the following pipette schedule was followed:
Solution A: 0.1 M citric acid +0.2 M Na₂HPO₄.2 H₂O₁ pH=5.5
Solution B: 0.189 M L-asparagine (Sigma)
Solution C: 0.006 M (NH₄)₂SO₄ (Merck)
Solution D: 25% (v/v) trichloroacetic acid (Merck)
Solution E: Ammonia Color Reagent (Aldrich)

The solutions for asparaginase activity measurements have to be prepared freshly. In Table 1, the solutions used for the calibration curve (CP =calibration point) are summarized.

TABLE 1
Calibration solution schedule

| | | | | | Reference | |
|---|---|---|---|---|---|---|
| | | | | | enzyme | Enzyme |
| Added solution (ml) | CP 1 | CP 2 | CP 3 | CP 4 | test | test |
| A | 1 | 1 | 1 | 1 | 1 | 1 |
| B | 0 | 0 | 0 | 0 | 0.2 | 0.2 |
| C | 0 | 0.25 | 0.5 | 1 | 0 | 0 |
| De−ionized water | 1.1 | 0.85 | 0.6 | 0.1 | 0.8 | 0.8 |
| Volume of reaction | 0 | 0 | 0 | 0 | 0 | 0.1 |
| rate−limiting amount | | | | | | |
| of the enzyme solution | | | | | | |

Solutions according to Table 1 were immediately inverted and incubated at 37° C. by inversion. After 30 minutes, the reaction was terminated by the addition of 0.1 ml of solution D. For the reference enzyme test, 0.1 ml enzyme solution was added subsequently. The solutions were immediately mixed and centrifuged to remove any precipitate. 0.2 ml of the supernatants were pipetted into tubes containing 4.3 ml deionized water and 0.5 ml solution E. These mixtures were immediately mixed, and after 1 minute the A^{436 nm} was measured for the calibration samples, references and tests.

The calibration curve was made as follows:
ΔA^{436 nm} calibration point=A^{436 nm} calibration point−A⁴³⁶ nm calibration point 1

A standard curve was prepared by plotting the ΔA^{436 nm} of the standard versus the ammonia (NH3) concentration.

The enzyme activity was calculated as follows:
ΔA^{436 nm} enzyme test=A^{436 nm} test A^{436 nm} test reference
The μmoles of NH₃ liberated were determined using the standard curve:

$$Units \text{/} ml = \frac{µmoles liberated {NH}_{3} \times {V}_{s}}{{V}_{t} \times {t}_{i} \times {V}_{e}}$$

where:
Vₛ =Volume reaction solution (in schedule +0.1 ml solution D); 2.2 ml
Vₜ =Volume of reaction solution used for second reaction to determine NH₃; 0.2 ml
tᵢ =incubation time in minutes; 30
Vₑ =volume enzyme sample to be tested; 0.1

$$Specific enzyme activity = \frac{units \text{/} ml enzyme}{mg protein \text{/} ml enzyme}$$

One unit of asparaginase activity is defined 1 μmole of NH₃ that is liberated from L-asparagine per minute at pH 5.5 at 37° C., unless stated otherwise. Preferably, the asparaginase activity is determined at the pH value of the intended application.

### Materials

Asparaginase was obtained from Escherichia coli (Sigma, having a specific activity of 285 units/mg), or Aspergillus niger (see examples for fermentation details).

CSL medium consisted of: 100 g/l Corn Steep Solids (Roquette), 1 g/l NaH₂PO₄*H₂O, 0.5 g/l MgSO₄*7H₂O, 10 g/l glucose*H₂O, 0.25 g/l Basildon (antifoam). The ingredients were dissolved in demineralized water, and the pH was adjusted to pH=5.8 with NaOH or H₂SO₄; 100 ml flasks with baffle and foam ball were filled with 20 ml fermentation broth and sterilized for 20 minutes at 120° C., after which 200 μl of a solution containing 5000 IU/ml penicillin and 5 mg/ml streptomycin was added to each flask after cooling to room temperature.

CSM medium consisted of: 150 g/l maltose*H₂O, 60 g/l Soytone (pepton), 1 g/l NaH₂PO₄*H₂O, 15 g/l MgSO₄*7H₂O, 0.08 g/l Tween 80, 0.02 g/l Basildon (antifoam), 20 g/l MES, 1 g/l L-arginine. The ingredients were dissolved in demineralized water and the pH was adjusted to pH=6.2 with NaOH or H₂SO₄; 500 ml flasks with baffle and foam ball were filled with 100 ml fermentation broth and sterilized for 20 minutes at 120° C., after which 1 ml of a solution containing 5000 IU/ml penicillin and 5 mg/ml streptomycin was added to each flask after cooling to room temperature.

### EXAMPLE 1

### Fermentation of Aspergillus niger

The asparaginase encoded by the nucleotide sequence provided in co-pending patent application PCT/EP03/14553 was obtained by constructing expression plasmids containing the DNA sequence, transforming an A. niger strain with this plasmid, and growing the Aspergillus niger strains in the following way.

Fresh spores (10⁶-10⁷) of A. niger strains were inoculated in 20 ml CSL-medium (100 ml flask, baffle) and grown for 20-24 hours at 34° C. and 170 rpm. After inoculation of 5-10 ml CSL pre-culture in 100 ml CSM medium (500 ml flask, baffle), the strains were grown at 34° C. and 170 rpm for 3-5 days.

Cell-free supernatants were obtained by centrifugation in 50 ml Greiner tubes (30 minutes, 5000 rpm, 4° C.), and all subsequent steps were performed on ice. The supernatants were pre-filtered over a GF/A Whatman Glass microfiber filter (150 mm Ø) to remove the larger particles, adjusted to pH=5 with 4 N KOH (if necessary) and sterile-filtrated over a 0.2 μm (bottle-top) filter with suction to remove the fungal material. The supernatant fractions were stored at 4° C. (or −20° C.).

### EXAMPLE 2

### Measurement of the Aspergillus Niger Asparaginase Content in the Ultra-Filtrate and Asparaginase activity

Step 1—Preparation of ultra-filtrates

Supernatant fractions of the cultures as obtained in Example1, were ultra-filtrated to obtain a higher enzyme concentration and to remove low molecular-weight contaminations that could interfere with the enzymatic activity determinations and the application tests. Ultra-filtrations of 300 ml supernatant were performed in a Millipore Labscale TFF system equipped with a filter with a 10 kDa cut-off.

Depending on their color and volume, the samples were washed 3-5 times with 10-30 ml of cold demineralized water. The final volumes of the enzyme solutions were 10-30 ml, and these solutions are further referred to as “ultra-filtrates”.

Step 2 —Determination of the Asparaginase Concentration by A²⁸⁰ and HPSEC

The concentration of the Aspergillus niger asparaginase in the ultra-filtrate was calculated from the extinction at 280 nm (A²⁸⁰) attributable to the asparaginase and the calculated molar extinction coefficient of the asparaginase. Measurement of the A²⁸⁰ was performed in a Uvikon XL Secomam spectrophotometer (Beun de Ronde, Abcoude, The Netherlands).

The molar extinction coefficient of an enzyme at 280 nm can be calculated from the number of tyrosine, tryptophan, and cysteine residues per enzyme molecule (S.C. Gill and P.H. von Hippel, Anal. Biochem. 182, 319-326 (1989)). The molar extinction coefficients of these amino acids at 280 nm are 1280, 5690 and 120 M⁻¹.cm⁻¹, respectively. The number of tyrosine, tryptophan and cysteïne residues in the Aspergillus niger asparaginase of the invention can be deduced from the protein sequences as given in co-pending patent application PCT/EP/03/14553. The calculated extinction coefficient of the Aspergillus niger asparaginase is in given Table 2.

TABLE 2
Extinction coefficient of A. niger asparaginase

| # of | | | Calculated | Calculated extinction | |
|---|---|---|---|---|---|
| amino acids | | | M.W. | coefficient at 280 nm | |
| Trp | Tyr | Cys | (Da) | M⁻¹ · cm⁻¹ | (mg/ml)⁻¹ · cm⁻¹ |
| 0 | 9 | 2 | 39584 | 11760 | 0.3 |

The extinction of the ultra-filtrate at 280 nm (A ²⁸⁰) that is attributable to the asparaginase depends on the purity of the enzyme sample. This purity was determined using HPSEC (High Performance Size Exclusion Chromatography) with a TSK SW-XL column (300*7.8 mm; MW range 10-300 kDa). Elution was performed with a 25 mM sodium phosphate buffer (pH=6.0), at a flow of 1 ml/min. The injection volume was 5-100 μl. The absorbance was monitored at 280 nm.

The A²⁸⁰ in the ultra-filtrate attributable to the asparaginase of the invention, was obtained from the ratio of the peak surface of the asparaginase peak in the chromatogram and the total surface of the peaks absorbing at 280 nm. The asparaginase concentration in the ultra-filtrate was then calculated by multiplying the A²⁸⁰ of the ultra-filtrate with this ratio, and dividing by 0.3 (the calculated extinction coefficient). The solution contained 40 mg protein/ml.

Step 3 —Determination of Asparaginase Activity

The Aspergillus niger asparaginase solution showed an activity of 40000 U/ml at pH 5.5. Therefore, a specific activity of 1000 units/mg protein can be calculated taking into account the protein content of 40 mg/ml.

### EXAMPLE 3

### Preparation of French Fries, and the influence of Aspergillus Niger Asparaginase on the Acrylamide Level

Potatoes (variety Bintje; [sample: start material]) were peeled with a knife peeler (Glastra) and cut to strips (Slitmaster) of 50×10×10 mm. Off-shape cuts were discarded. From these cut potatoes, per solution ca. 1600 g French fries were selected. The French fries were blanched (2 min 80° C. +20 min 65° C.) and cooled in cold water (1 min). At this moment, a sample was taken from blank [sample: after blanching]. After cooling, the French fries were dipped in one of the following solutions in 4.5 L tap water of 35° C:

TABLE 3.1
Sample treatment during preparation of French fries

| Code | Treatment | Treatment time | Solution in 4.5 L tap water |
|---|---|---|---|
| 1 | Blank | 10 min. | 0.5% SAPP (Na₂H₂P₂O₇), pH = 5 |
| 2 | 11500 U/L | 10 min. | 0.5% SAPP, 11.25 ml asparaginase |
| | | | solution |
| 3 | 4600 U/L | 10 min. | 0.5% SAPP, 4.5 ml asparaginase |
| | | | solution |
| 4 | 1800 U/L | 10 min. | 0.5% SAPP, 1.8 ml asparaqinase |
| | | | solution |

The asparaginase solution used had a strength of 4600 U/ml. It must be realized that the exact enzyme dosage is not a relevant number, because it is influenced by the ratio between the potatoes and the volume of the soaking solution in this particular method of application. For convenience sake, rather large volume was used, and hence rather large volumetric enzyme dosages were required.

Subsequently, the French fries were dried at 70° C. until a weight loss of 13-15% had occurred, and par-fried in oil (liquid palm fat, Rodi) for 1 min at 180° C. in a commercial batch 35-litre fryer (ANBO). The par-fried French fries were cooled (20 min at 3° C.), frozen (20 min at −30° C.) in Pool equipment and stored overnight at −20° C. [sample: par-fried]. The next day, 750 g deep-frozen French fries were finish-fried for 3 min at 180° C. in a commercial batch 35-litre fryer (ANBO) and pictures were taken.

Then, the color was measured (see later) and a random sample of 20 fries was taken [sample: finish-fried whole]. An extra sample was frozen lightly and the crust was separated from the core [samples: finish-fried crust and finish-fried core]. All samples were frozen quickly with liquid nitrogen, kept deep-frozen and subsequently freeze- dried. The mass of the samples after freezing with liquid nitrogen and after freeze-drying was measured in order to get an indication of the dry matter content.

Table 3.2 shows the results of the dry matter content of the samples, based on mass before and after freeze-drying.

TABLE 3.2
Dry matter of different samples potato material and French fries

| | | | Dry matter |
|---|---|---|---|
| Code | Treatment | Sample | (%) |
| | Peeled potato | start material | 23.4% |
| | Blank before enzyme treatment | after blanching | 18.5% |
| 1 | Blank, 10 min, no enzyme | par-fried | 31.6% |
| | | finish-fried whole | 45.1% |
| | | finish-fried crust | 63.0% |
| | | finish-fried core | 27.4% |
| 2 | 10 min, 11.5 ml enzyme in 4.5 L | par-fried | 32.1% |
| | | finish-fried whole | 47.5% |
| | | finish-fried crust | 66.6% |
| | | finish-fried core | 27.6% |
| 3 | 10 min, 4.5 ml enzyme in 4.5 L | par-fried | 30.4% |
| | | finish-fried whole | 45.1% |
| | | finish-fried crust | 65.9% |
| | | finish-fried core | 26.2% |
| 4 | 10 min, 1.8 ml enzyme in 4.5 L | par-fried | 29.6% |
| | | finish-fried whole | 43.3% |
| | | finish-fried crust | 64.4% |
| | | finish-fried core | 25.5% |

It is clear that the enzyme treatment did not significantly influence the dry matter content of the various samples.

The color of the French fries (finish-fried) was determined with the Fries Colour Test (Ferguson, BMA, The Netherlands). The FCT was calibrated with the Gretag Macbeth color checker Color Rendition Chart. At random, 20 strips were taken from a fried batch and put on a blue plate. The color was determined by computer image analysis of each individual strip and categorized from the USDA color cart with the scale ‘000’, ‘00’, ‘0’, ‘1’, ‘2’, ‘3’and ‘4’. Based on the measurement of the individual strips, the (Frying) Colour Index (KLI) was calculated. The scale of the KLI runs from 0 to 6, in which 0 is white yellow and 6 is dark brown. French fries with a KLI-value >4 are considered too dark.

Table 3.3 shows the results of the color index, determined by FCT. There was no systematic influence of the enzyme treatment on color development. With this measurement method, sample 2, 3 and 4 were not significantly different from sample 1. Visual inspection of the samples gave no difference in visual appearance of the samples.

TABLE 3.3
Colour index (KLI) determined with FCT

| Code | Treatment | FCT |
|---|---|---|
| 1 | blank, 10 min, no enzyme | 2.50 |
| 2 | 10 min, 11.5 ml enzyme in 4.5 L | 2.35 |
| 3 | 10 min, 4.5 ml enzyme in 4.5 L | 2.35 |
| 4 | 10 min, 1.8 ml enzyme in 4.5 L | 2.30 |

The freeze-dried samples were analyzed for their content of the amino acids asparagine, aspartate, glutamine and glutamate, using HPLC, and for acrylamide using the method described earlier.

It was found that the levels of all these amino acids were reduced by the blanching step. Moreover, the concentrations of these amino acids were also lower in the crust samples than in the core of the finish-fried products. In fact, the amino acid concentrations in the core were essentially the same as in the raw potato. In contrast, the treatment with asparaginase showed a dose-dependent conversion of asparagine to

TABLE 3.4
Amino acid and acrylamide levels in the
crust of finish−fried French fries

| Code | Treatment | asparagine | aspartate | Acrylamide |
|---|---|---|---|---|
| 1 | blank, 10 min, no enzyme | +++ | + | +++ |
| 2 | 10 min, 11.5 ml | +/− | ++ | +/− |
| | enzyme in 4.5 L | | | |
| 3 | 10 min, 4.5 ml | + | ++ | + |
| | enzyme in 4.5 L | | | |
| 4 | 10 min, 1.8 ml | ++ | + | ++ |
| | enzyme in 4.5 L | | | |

Hence, using asparaginase it has proven possible to obtain French Fries with a very low asparagine concentration in their crust, resulting in much lower levels of acrylamide, While maintaining a high level of amino acids of a virtually unchanged composition in their interior.

It can be concluded that the use of asparaginase in a soaking solution decreases the amount of acrylamide formed in the crust of French fries during a subsequent deep-frying process.

It has been found that the amino acid content of the interior of a French fry was not significantly affected by the complete treatment of blanching, dipping, par-frying, freezing, and finish-frying. Therefore can be concluded that if one were to measure in non-fractionated fries, any change observed in the levels of these amino acids, must be due to changes in the composition of the outer sections, that are going to form the crust after the frying process. Hence, reductions in asparagine or glutamine levels exceeding 30% when measured in the intact fry, must be regarded as highly significant, and sufficient for the purpose of preventing acrylamide formation in the subsequent frying process.

1. Process for the production of a food or feed product comprising:
adding an enzyme to the surface of an intermediate form of the food or feed product,
and heating at least a part of the intermediate food or feed product to a temperature of 1000° C. or higher,
whereby the enzyme is capable to modify an amino acid present in the intermediate form of the food product and which amino acid is involved in the formation of acrylamide in absence of the enzyme during the heating of the intermediate food product.

2. Process according to claim 1 wherein the enzyme is capable of modifying a side chain of the amino acid preferably of the amino acid asparagine or glutamin.

3. Process according to claim 1, whereby the enzyme is added in an amount sufficient to modify an amino acid to such an extent, that 50% less, preferably 70% less, or more preferably 90% less acrylamide is formed during the subsequent heating step, compared with a food or feed product where no enzyme has been added to the intermediate form.

4. Process according to claim 1, whereby the heating of the intermediate food or feed product takes place by applying heat from the outside.

5. Process according to claim 1 wherein the food or feed product is made from at least one plant raw material.

6. Process according to claim 1 wherein the plant raw material is derived from cereal or potato.

7. Process according to claim 1 wherein the enzyme is added as an enzyme preparation or is produced in situ by a microorganism capable of producing said enzyme.

8. Process according to claim 7 wherein the enzyme preparation is derived from a microorganism, preferably a bacterium, a fungus or a yeast.

9. Process according to claim 8 wherein the enzyme preparation is derived from the fungus Aspergillus.

10. Process according to claim 1 wherein the enzyme is asparaginase (EC 3.5.1.1) or glutaminase (EC 3.4.1.2).

11. Use of an asparaginase in a process for the production of a food or feed product according to claim 1.

12. A food or feed product obtainable by the process according to claim 1.
